(19) United States
(12) Patent Application Publication
(10) Pub. No.: US 2024/0051243 A1
(43) Pub. Date: Feb. 15, 2024

(54) CONTROLLED BOBBIN HOLDER FOR A THREAD WINDING UNIT

(71) Applicant: COMMISSARIAT À L'ENERGIE ATOMIQUE ET AUX ENERGIES ALTERNATIVES, PARIS (FR)

(72) Inventors: Christophe MAGNIER, MONTS (FR); Stéphane VILLALONGA, MONTS (FR)

(73) Assignee: COMMISSARIAT À L'ENERGIE ATOMIQUE ET AUX ENERGIES ALTERNATIVES, PARIS (FR)

(21) Appl. No.: 18/259,310

(22) PCT Filed: Dec. 24, 2021
(86) PCT No.: PCT/FR2021/052456

§ 371 Date: Jun. 26, 2023

(30) Foreign Application Priority Data
Dec. 24, 2020 (FR) FR2014078

(51) Int. Cl. B29C 70/38; B65H 49/32; B29C 70/32

(52) U.S. Cl. CPC B29C 70/384; B65H 49/32; B29C 70/32; B65H 2553/40; B65H 2701/38; B29L 2031/7156

(57) ABSTRACT

A device for unwinding a strand from a bobbin, which includes: a plate supporting at least one bobbin holder, which extends along an axis substantially perpendicular to the plate and is intended to receive a bobbin capable of rotating about the axis of the bobbin holder; an element for translationally moving the bobbin along the axis of the bobbin holder; and an element for controlling the movement element and configured so as to maintain the strand leaving the bobbin in a substantially constant position along the axis of the bobbin holder.

### FIELD

The present document relates to a controlled bobbin holder for a thread winding unit able to wind at least one strand of a bobbin around an object such as a hollow mandrel intended to form a reservoir which can, for example, receive pressurized fluid, such as in particular hydrogen gas.

### BACKGROUND

Thread winding is a method for implementing by molding composite materials in the form of parts having an axis of revolution (cylinder, cone, etc.). This method is suitable for mass production and is mainly used to manufacture parts subjected to high mechanical stresses (tanks, pipes, etc.).

FIG. 1 represents a thread winding unit 10, according to the known technique, comprising a mandrel 12 rotatably mounted on a frame 14 and around a substantially horizontal longitudinal axis A. The unit 10 comprises a dispenser 16 movable in translation along the longitudinal axis A and supporting a plurality of bobbins 18 extending substantially perpendicularly to a panel of the dispenser and substantially horizontally. Each bobbin 18 comprises a strand 20, which are brought together next to each other at a laying head 22 so as to form a sheet. The laying head 22 is secured to the dispenser 16 via a carriage 24 movable in translation along the longitudinal axis A.

In some configurations (not represented), the laying head can also move in a direction transverse to the axis of the mandrel, turn around said transverse axis, pivot around the longitudinal axis, and possibly move on the vertical axis.

Prior to starting up the thread winding unit, the sheet is attached to the mandrel. Tensioners of the dispenser are activated to tension the fibers, limit shrinkage and compact the deposited successive layers as well as possible. A layer is defined by a winding allowing depositing the sheet over the entire surface of the mandrel that one wishes to cover. It is possible to create a helical type layer with the sheet that is deposited by forming helices in order to cover the entire surface of the cylinder and the desired areas in the hemispherical bottoms. It is possible to make a circumferential type layer where the sheet is deposited almost transversely to the axis of the mandrel over all or over a portion of the cylindrical area of the mandrel.

Structuring by thread winding allows stacking a succession of helical and/or circumferential layers in order to achieve the desired mechanical performances of the object. In general, the machine is controlled by a numerical control. This numerical control is often programmed by an operator using software dedicated to thread winding.

Contact laying machines are known which enable laying of tapes with a short length without any risk of spinning. However, these machines do not allow laying and maintaining a long continuous fiber under tension or axial mechanical stress in the direction of the fiber which is imposed and regulated.

Known processes of this type are ATL standing for Automated Tape Layer and AFP standing for Automated Fiber Placement.

The ATL process uses very wide tapes (generally from 100 to 300 mm). This technique enables deposition over surfaces with a small radius of curvature and large dimensions such as the wing of a civil aircraft. The AFP process carries out a juxtaposition of tape less than 10 mm wide and an assembly at the head outlet of up to 32 tapes.

The main applications are making of planar parts or parts with a large radius of curvature. The main idea is to replace the human hand for laying down successive plies with defined fiber orientations.

All current systems use calibrated pre-impregnated tapes (fiber/resin) with a separation film between the layers on the storage bobbin. These calibrated tapes are derived from unidirectional pre-impregnated sheets recut with the risk of partial cutting of the reinforcement on the edges. The material costs are herein high and it is necessary to have a system for winding the separation film during the draping operations.

None of these systems uses standard pre-impregnated fibers, i.e. with no separation film between the layers for implementation by thread winding. It is not possible to apply a continuous tension (or stress) in tension (in the direction of the fiber) on the strands since the strand(s) making up the sheet are cut at each end of the made part.

To date, the successive developments in the field of implementation of composite materials have for a large part been concentrated on the automation of processes. These developments are driven by the huge needs expressed in the automotive and aeronautics sectors. The development of hydrogen storage technologies (for example at 700 bar operating pressure) with the increase in gravimetric capacity (i.e. the ratio between the amount of stored hydrogen and the mass of the container), pushes composite materials to the limits of use.

Conventional thread winding processes (dedicated machines) and more robotic ones (versatile machines) have never taken into account the full impact of the process in the loss of performance. In most cases, the bobbin support is far away from the laying head and the strands pass through a large number of deflections and rollers before reaching the laying head.

Currently, systems for unwinding strands (from the bobbins that store the material) on thread winding machines are made without taking into account the effects of unwinding on the geometry and the mechanical performance of the strand. Most systems, whether mechanical (fixed setting of the tension applied to the strand) by springs or belt or electronic (modulated setting of the tension applied to the strand), are simple systems for unwinding the strand from the bobbin. Yet, the strand of each bobbin is wound on the rod of the bobbin with a spooling angle which induces a movement of the strand along the rod of the bobbin. When the guide member at the outlet of the bobbin is a deflection rod, it should be understood that the strand moves along the rod. When the guide member at the outlet of the bobbin is a deflection roller, the strand forms an angle oscillating around 90°. In either case, the movement of the strand relative to the deflection member is likely to spin the strand, which might lead to manufacturing defects when laying the strand over the mandrel.

This problem is even more increased when the strand of the bobbin is pre-impregnated with a curable partially polymerized matrix such as a thermosetting matrix or a thermoplastic matrix. Indeed, the stickiness considerably limits slipping the strand, and even makes it impossible, which prevents any movement thereby allowing limiting the formation of a spin when it is initiated.

To limit the formation of spins, it is known to place the bobbins away from the deflection members and therefore from the laying head, which poses a problem of footprint of the thread winding machine.

### SUMMARY

A device for unwinding a strand from a bobbin is provided comprising:
a plate supporting at least one bobbin holder extending according to an axis substantially perpendicular to the plate and intended to receive a bobbin able to rotate around said axis of the bobbin holder;
means for translationally moving the bobbin according to the axis of the bobbin holder
means for controlling the movement means configured to enable maintenance of the strand leaving the bobbin at a substantially constant axial position, i.e. along the axis of the bobbin holder.

The control of the movement of the bobbin allows preserving the geometry of the strand of the bobbin being unwound. It should be understood that the axial position of the bobbin is not strictly constant in mathematical terms but is kept substantially constant so that its position seems to be constant and prevents the formation of spins.

The bobbin may be a bobbin of a strand formed by a plurality of reinforcing fibers or filaments. The fibers may be carbon fibers.

The movement means may comprise means for guiding a connecting part in translation according to an axis parallel to the axis of the bobbin holder, this connecting part being connected to a bobbin support surrounding the bobbin holder, the bobbin support being coupled in rotation to the bobbin-holder and free to translate along the bobbin holder.

The connecting part may be connected in rotation about the longitudinal axis to the bobbin support and is secured in translation along said axis with said bobbin holder.

According to another feature, the guide means may comprise at least one rod substantially perpendicular to the plate and in which the connecting part is slidably guided.

The movement means may comprise a motor coupled in rotation by a belt to a worm screw driving the connecting part in translation.

The bobbin holder may be rotatably mounted relative to the connecting part.

A roller bearing may be mounted at the junction of the bobbin support and the connecting part.

The bobbin holder comprises ball bearings for the translational movement of the bobbin holder.

The bobbin holder may be rotatably mounted on the plate.

The control means may comprise means for detecting the axial position of the strand leaving the bobbin.

The detection means may comprise two position sensors, for example of the optical type or others, spaced axially apart from each other and configured to detect the passage of the strand.

A unit for winding at least one strand of a bobbin by means of a device according to one of the preceding claims.

### BRIEF DESCRIPTION OF THE DRAWINGS

Other features, details and advantages will appear upon reading the detailed description hereinafter, and upon analyzing the appended drawings, wherein:

FIG. 1, already described before, is a schematic perspective view of a thread winding unit according to the prior art;

FIG. 2 and

FIG. 3 are schematic perspective views according to two different orientations of a device according to the present document;

FIG. 4 is a schematic perspective view of the bobbin holder with an enlargement at the right portion of the portion surrounded in dotted lines;

FIG. 5 is a perspective diagram of a bobbin holder and a bobbin holder surrounding the bobbin holder;

FIG. 6 is a schematic view similar to that of FIG. 5 wherein the bobbin holder has been removed;

FIG. 7 is a schematic perspective view of the bobbin holder with an enlargement at the right portion of the portion surrounded in dotted lines, a partial section being made to show the connection between the connecting part and the bobbin holder;

FIG. 8 is a schematic perspective view of a device for unwinding a bobbin mounted on a bobbin holder which is in a first position in 8A and in a second position 8B.

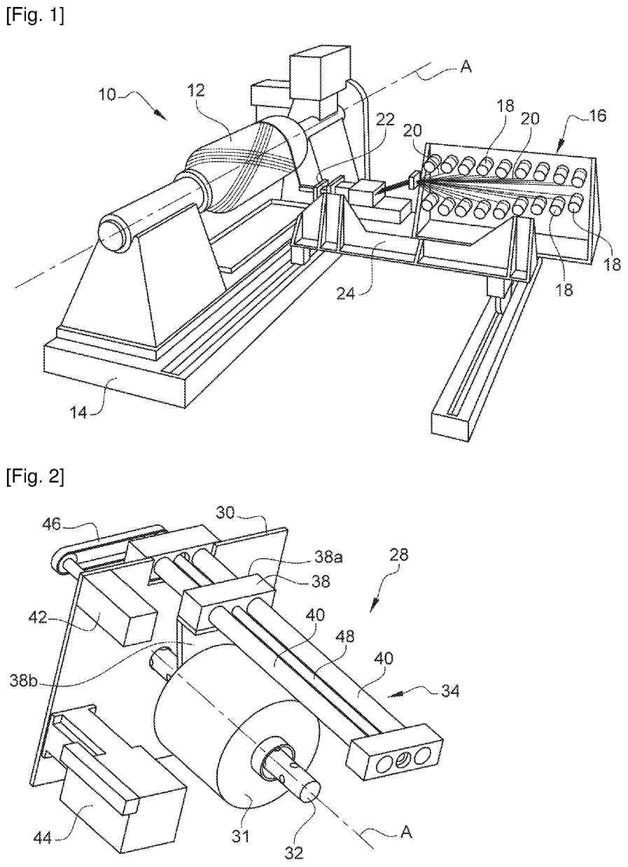

### DETAILED DESCRIPTION

Reference is now made to FIG. 2 which represents an unwinding device 28 according to the present document and which comprises a plate 30. One could observe that a bobbin 31 is supported by the plate 30 and on one side which is opposite to that intended to support a laying head (not represented).

Thus, the plate 30 comprises a bobbin 31 but could support several ones. The bobbin(s) 31 extend(s) along a longitudinal axis A which may be parallel to the longitudinal axis of the laying head. Reference will now be made to one single bobbin 31 although the plate 32 could comprise several ones.

The device 28 comprises a bobbin holder 32 surrounded by a bobbin 31 support 36, the bobbin 31 being mounted secured in rotation with the bobbin 31 support 36, for example by a clamped mounting or any other suitable mounting. The bobbin holder 32 and the bobbin support 36 are coaxial along an axis A substantially perpendicular to the plate 30.

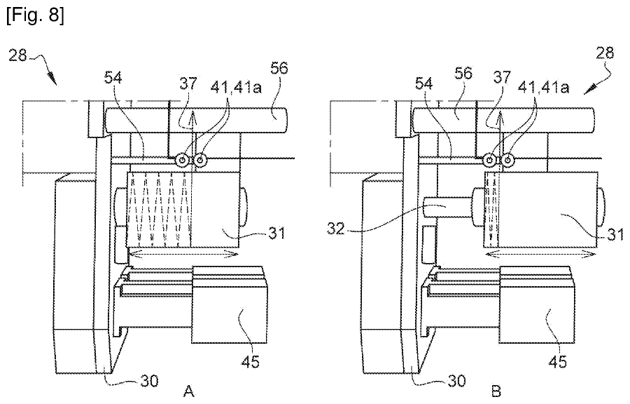

The device 28 comprises means 34 for translationally moving the bobbin 31 according to the axis A of the bobbin holder 32 and means 41 for controlling the moving means configured to enable maintenance of the strand 37 (FIG. 8) of the bobbin 31 at a substantially constant axial position.

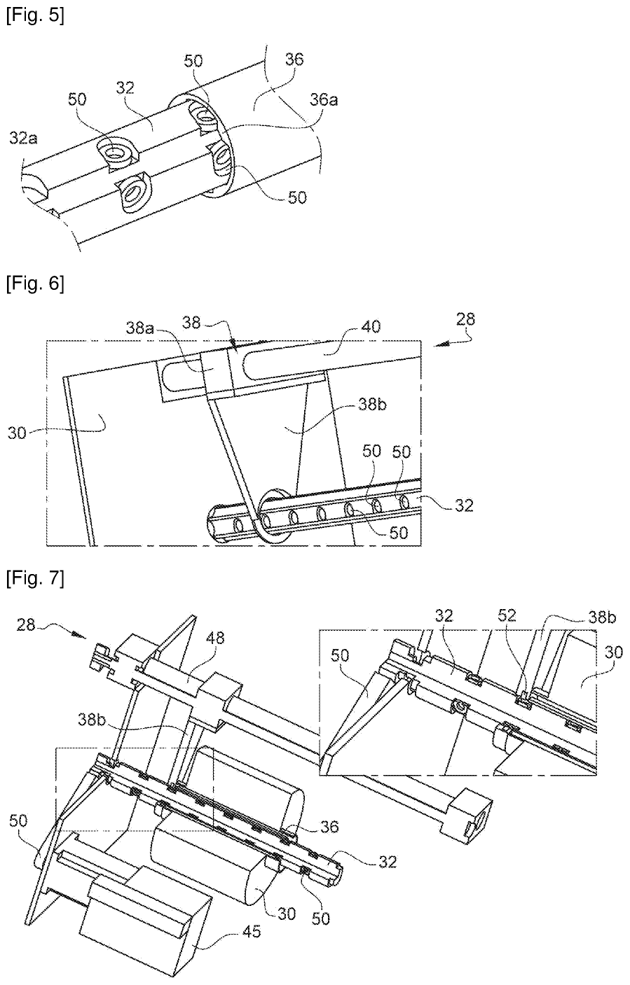

The movement means 34 comprise means for guiding a connecting part 38 in translation connected to the bobbin 31 support 36. This connecting part 38 includes an upper portion 38a for sliding in translation crossed by two rails 40 or guide rods parallel to the longitudinal axis A of the bobbin holder 32. The upper portion 38a is able to slide on the two rails 40. The upper portion 38a of the connecting part 38 is connected to a bracket 38b whose end opposite to the upper portion 38a is connected in rotation to the bobbin 31 support 36 and is secured in translation along said axis A of said bobbin 31 support 36 as will appear better with reference to FIGS. 4 to 7. The movement means 34 comprise a motor 42 whose output shaft 44 is coupled in rotation by a belt 46 to a worm screw 48 driving the connecting part 38 in translation. More particularly, the worm screw 48 passes through the upper portion 38a of the connecting part 38 and is coupled in rotation thereto via a thread so that the rotation of the screw 48 causes the translational movement according to the longitudinal axis A of the connecting part 38 and consequently of the bobbin 31 support 36 and therefore of the bobbin 31.

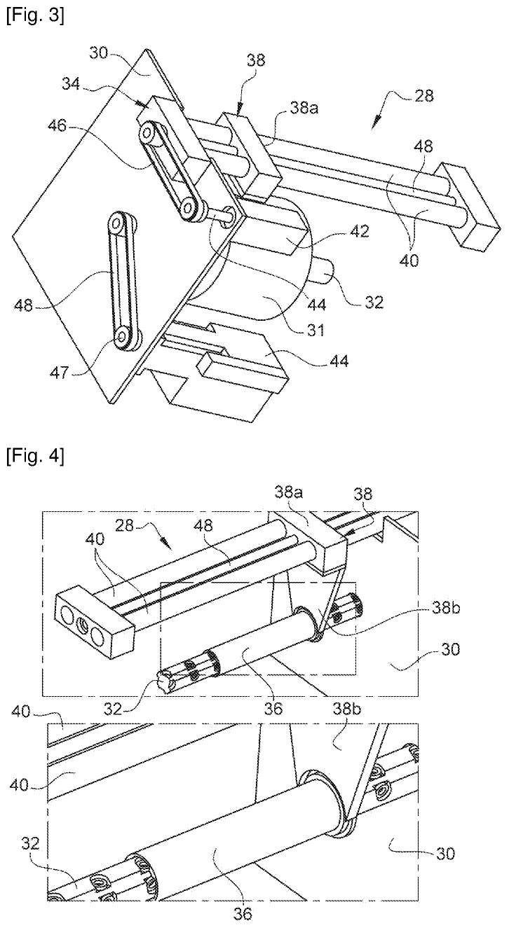

In FIG. 3, one could observe the presence of a motor 45 intended to generate a voltage in the strand 37 of the bobbin 31. The output shaft 47 of this motor 45 is coupled to the bobbin holder 32 by a belt 51. A tensioner could be used to tension the belt 46 and/or the belt 51.

Reference is now made to FIGS. 4, 5 and 6 which illustrate the bobbin 31 support 36 coupled in translation to the bracket 38b of the connecting part. The bobbin 31 support 36 is mounted in translation along the longitudinal axis A on the bobbin holder 32 and is able to slide along said longitudinal axis A on the bobbin holder 32. The bobbin 30 support 36 is coupled in rotation to the bobbin holder 32 via a corresponding shape. More specifically, the inner face of the bobbin 31 support 36 comprises longitudinal ribs 36a fitted in longitudinal grooves 32a of the bobbin holder 32. The bobbin holder 32 comprises ball bearings 50 for the translational movement of the bobbin 31 support 36 on the bobbin holder 32. In this manner, the bobbin holder 32 is connected in rotation to the bobbin holder 36 which carries the bobbin 31 and the bobbin 31 holder 36 can slide on the bobbin holder 32.

In order to guarantee a rotation of the bobbin 31 support 36 relative to the connecting part 38 which is fixed in rotation, a bearing is formed at the annular junction of the bracket 38b and the bobbin 31 support 36. This bearing may be formed by an annular flange 52 of the bobbin 31 support 36 which is mounted in an annular groove of the bracket 38b. Thus, it may consist of a plain bearing. It would also be possible to make a connection by a roller bearing with an outer ring secured to the bracket 38b and with an inner ring secured to the bobbin 31 support 36 (FIG. 7).

In order to ensure control of the motor 42 for the translational movement of the bobbin 31 support 36, the control means 41 comprise means 41a for detecting the axial position of the strand 37 leaving the bobbin 31, these detection means comprising for example two optical position sensors 41a spaced longitudinally apart from each other and configured to detect the passage of the strand 37. These optical sensors 41a may be supported by a rod 54 parallel to the longitudinal axis A (FIG. 8).

FIG. 8 illustrates two positions along the axis A of the bobbin 30 and therefore of the bobbin 30 support 36. One could observe that with the device 28 according to the present document, the strand 37 always leaves the bobbin 31 according to a direction substantially perpendicular to the axis of the bobbin. The position of the strand along the longitudinal axis remains constant, which allows using a deflection roller or a deflection rod 56 without any risk of spin formation.

1-12. (canceled)

13. A device for unwinding a strand from a bobbin comprising:
a plate supporting at least one bobbin holder extending according to an axis (A) substantially perpendicular to the plate and intended to receive a bobbin able to rotate around said axis of the bobbin holder;
means for translationally moving the bobbin according to the axis of the bobbin holder;
means for controlling the movement means configured to enable maintenance of the strand leaving the bobbin at a substantially constant position along the axis (A) of the bobbin holder.

14. The device according to claim 13, wherein the movement means comprise means for guiding a connecting part in translation according to an axis parallel to the axis of the bobbin holder, this connecting part being connected to a bobbin support surrounding the bobbin holder, the bobbin support being coupled in rotation to the bobbin holder and free to translate along the bobbin holder.

15. The device according to claim 14, wherein the connecting part is connected in rotation about the longitudinal axis (A) to the bobbin support and is secured in translation along said axis (A) with said bobbin holder.

16. The device according to claim 14, wherein the guide means comprise at least one rod substantially perpendicular to the plate and in which the connecting part is slidably guided.

17. The device according to claim 14, wherein the movement means comprise a motor coupled in rotation by a belt to a worm screw driving the connecting part in translation.

18. The device according to claim 14, wherein the bobbin holder is rotatably mounted relative to the connecting part.

19. The device according to claim 18, wherein a roller bearing is mounted at the junction of the bobbin support and the connecting part.

20. The device according to claim 14, wherein the bobbin holder comprises ball bearings for the translational movement of the bobbin holder.

21. The device according to claim 13, wherein the bobbin holder is rotatably mounted on the plate.

22. The device according to claim 13, wherein the control means comprise means for detecting the axial position of the strand leaving the bobbin.

23. The device according to claim 22, wherein the detection means comprise two position sensors, for example optical, spaced axially apart from each other and configured to detect the passage of the strand.

24. A unit for winding at least one strand of a bobbin by means of a device according to claim 13.
